(19) United States
(12) Patent Application Publication
(10) Pub. No.: US 2026/0148111 A1
(43) Pub. Date: May 28, 2026

(54) COMMUNICATION METHOD AND COMMUNICATION APPARATUS

(71) Applicant: Huawei Technologies Co., Ltd., Shenzhen (CN)

(72) Inventors: Yiqun Ge, Ottawa (CA); Hao Tang, Ottawa (CA); Jianglei Ma, Ottawa (CA)

(21) Appl. No.: 19/415,192

(22) Filed: Dec. 10, 2025

Related U.S. Application Data
(63) Continuation of application No. PCT/CN2023/125045, filed on Oct. 17, 2023.
(60) Provisional application No. 63/507,803, filed on Jun. 13, 2023.

(51) Int. Cl. G06N 5/04

(52) U.S. Cl. CPC G06N 5/04

(57) ABSTRACT

Embodiments of the present application provide a communication method and a communication apparatus. The communication method includes: obtaining distance(s) between q reference distribution(s) and distribution(s) of q layer(s) of a first AI model in an inference cycle, where the q reference distribution(s) corresponds to the q layer(s), and q is a positive integer; and sending first information according to the distance(s).

### CROSS-REFERENCE TO RELATED APPLICATIONS

The present application is a continuation of International Application No. PCT/CN 2023/125045, filed on Oct. 17, 2023, which claims priority to U.S. Provisional Ser. No. 63/507,803 , filed on Jun. 13, 2023.

The disclosures of the aforementioned applications are hereby incorporated by reference in their entirety.

### TECHNICAL FIELD

Embodiments of the present application relate to the field of communications, and more specifically, to a communication method and a communication apparatus.

### BACKGROUND

Artificial intelligence (AI)-based algorithms have been introduced into wireless communications to solve some wireless problems such as channel estimation, scheduling, channel state information (CSI) compression, positioning, beam-management, and so on. AI algorithm is a data-driven method that tunes some pre-defined architectures by a set of data samples called as a training data set.

Whether the AI model deployed on a device can work is crucial for communication quality. For example, in wireless communication, AI models deployed on different devices may need to work together. The AI models may be trained and provided by different providers. Moreover, it is hard for AI providers to open their AI models. This may result in the AI models not working together, which can affect the communication quality.

Therefore, an urgent technical problem that needs to be solved is how to ensure communication quality.

### SUMMARY

Embodiments of the present application provide a communication method and a communication apparatus. The technical solutions may ensure communication quality.

According to a first aspect, an embodiment of the present application provides a communication method, including: obtaining distance(s) between q reference distribution(s) and distribution(s) of q layer(s) of a first AI model in an inference cycle, where the q reference distribution(s) corresponds to the q layer(s), and q is a positive integer; and sending first information according to the distance(s) between the q reference distribution(s) and the distribution(s) of the q layer(s) of the first AI model.

According to the above technical solution, the distance(s) can be used to check whether the first AI model can work as expected, which is conducive to ensuring communication quality.

In a possible design, the q layer(s) includes one or more latent layers of the first AI model.

In a possible design, the distance(s) between the q reference distribution(s) and the distribution(s) of the q layer(s) of the first AI model is configured to check whether the first AI model works with a second AI model.

In some scenarios, a plurality of AI models need to work together. These AI models may be trained independently by different providers. If these AI models cannot work together, the accuracy of communication content may not be guaranteed, affecting communication quality.

According to the above technical solution, the distance(s) can be used to check whether the first AI model works with the second AI model, which is conducive to ensuring the quality of data processing or communication.

In a possible design, the q reference distribution(s) is distribution(s) of the q layer(s) of the second AI model.

In a possible design, the distance(s) between the q reference distribution(s) and the distribution(s) of the q layer(s) of the first AI model and distance(s) between the q reference distribution(s) and distribution(s) of the q layer(s) of the second AI model are configured to check whether the first AI model works with the second AI model.

In a possible design, the method further includes: receiving second information indicating the q reference distribution(s).

In a possible design, a reference distribution in the q reference distribution(s) may be in a form of a plurality of reference data samples.

In a possible design, a reference distribution in the q reference distribution(s) may be represented by one or more standard distributions.

Optionally, a reference distribution in the q reference distribution(s) may be in a form of a combination of multiple parameterized standard distributions.

Optionally, the q reference distribution(s) may be in a form of the parameterized standard distribution.

The reference distribution represented by one or more standard distributions saves much more radio resources than the reference distribution represented by a plurality of reference data samples.

In a possible design, the method further includes: receiving third information indicating q scoring function(s), where the q scoring function(s) is configured to measure the distance(s) between the q reference distribution(s) and the distribution(s) of the q layer(s) of the first AI model.

In a possible design, the first information indicates the distance(s) between the q reference distribution(s) and the distribution(s) of the q layer(s) of the first AI model.

According to a second aspect, an embodiment of the present application provides a communication method, including: receiving first information related to distance(s) between q reference distribution(s) and distribution(s) of q layer(s) of a first AI model in an inference cycle, where the q reference distribution(s) corresponds to the q layer(s), and q is a positive integer.

In a possible design, the method further includes: receiving second information indicating the q reference distribution(s).

In a possible design, the q layer(s) includes one or more latent layers of the first AI model.

In a possible design, the distance(s) between the q reference distribution(s) and the distribution(s) of the q layer(s) of the first AI model is configured to check whether the first AI model works with a second AI model.

In a possible design, the q reference distribution(s) is distribution(s) of the q layer(s) of the second AI model.

In a possible design, the distance(s) between the q reference distribution(s) and the distribution(s) of the q layer(s) of the first AI model and distance(s) between the q reference distribution(s) and distribution(s) of the q layer(s) of the second AI model are configured to check whether the first AI model works with the second AI model.

In a possible design, the method further includes: sending third information indicating q scoring function(s), where the q scoring function(s) is configured to measure the distance(s) between the q reference distribution(s) and the distribution(s) of the q layer(s) of the first AI model.

In a possible design, the first information indicates the distance(s) between the q reference distribution(s) and the distribution(s) of the q layer(s) of the first AI model.

According to a third aspect, a communication apparatus is provided. The communication apparatus includes a function or unit configured to perform the method according to the first aspect or any one of the possible designs of the first aspect.

For example, the communication apparatus may be a network device or a chip in the network device. For another example, the communication apparatus may be a terminal device or a chip in the terminal device.

According to a fourth aspect, a communication apparatus is provided. The communication apparatus includes a function or unit configured to perform the method according to the second aspect or any one of the possible designs of the second aspect.

For example, the communication apparatus may be a terminal device or a chip in the terminal device. For another example, the communication apparatus may be a network device or a chip in the network device.

According to a fifth aspect, a system is provided. The system includes: the communication apparatus according to the third aspect and the communication apparatus according to the fourth aspect.

According to a sixth aspect, a communication apparatus is provided. The communication apparatus includes at least one processor, and the at least one processor is coupled to at least one memory. The at least one memory is configured to store a computer program or one or more instructions. The at least one processor is configured to: invoke the computer program or the one or more instructions from the at least one memory and run the computer program or the one or more instructions, so that the communication apparatus performs the method in any one of the first aspect or the possible designs of the first aspect, or the communication apparatus performs the method in any one of the second aspect or the possible designs of the second aspect.

For example, the communication apparatus may be a network device or a component (for example, a chip or integrated circuit) installed in the network device. For another example, the communication apparatus may be a terminal device or a component (for example, a chip or integrated circuit) installed in the terminal device.

According to a seventh aspect, a communication apparatus is provided. The communication apparatus includes a processor and a communications interface. The processor is connected to the communications interface. The processor is configured to execute the one or more instructions, and the communications interface is configured to communicate with other network elements under the control of the processor. The processor is enabled to perform the method according to the first aspect or any one of the possible designs of the first aspect, or the second aspect or any one of the possible designs of the second aspect.

According to an eighth aspect, a computer storage medium is provided. The computer storage medium stores program code, and the program code is used to execute one or more instructions for the method according to the first aspect or any one of the possible designs of the first aspect, or the second aspect or any one of the possible designs of the second aspect.

According to a ninth aspect, the present application provides a computer program product including one or more instructions, where when the computer program product runs on a computer, the computer performs the method according to the first aspect or any one of the possible designs of the first aspect, or the second aspect or any one of the possible designs of the second aspect.

### DESCRIPTION OF DRAWINGS

FIG. 1 is a schematic diagram of an application scenario according to the present application;

FIG. 2 illustrates an example communication system 100;

FIG. 3 illustrates an example device in the communication system;

FIG. 4 is a schematic diagram of a device in two cycles according to an embodiment of the present application;

FIG. 5 illustrates example local data of a device according to an embodiment of the present application;

FIG. 6 illustrates an example data transmission between two devices according to an embodiment of the present application;

FIG. 7 is a schematic flowchart of a communication method according to an embodiment of the present application;

FIG. 8 is a schematic diagram of a distance between a reference distribution and the distribution of one latent layer according to an embodiment of the present application;

FIG. 9 shows a schematic diagram of an example interconnection check according to an embodiment of the present application;

FIG. 10 shows a schematic diagram of another example interconnection check according to an embodiment of the present application;

FIG. 11 shows a schematic diagram of another example interconnection check according to an embodiment of the present application; and

FIGS. 12-16 are schematic block diagrams of possible devices according to embodiments of the present application.

### DESCRIPTION OF EMBODIMENTS

The following describes technical solutions of the present application with reference to the accompanying drawings.

The embodiments of the present invention may be applied to communication systems of next generation (e.g., sixth generation (6G) or later), 5th Generation (5G), new radio (NR), long term evolution (LTE), or the like.

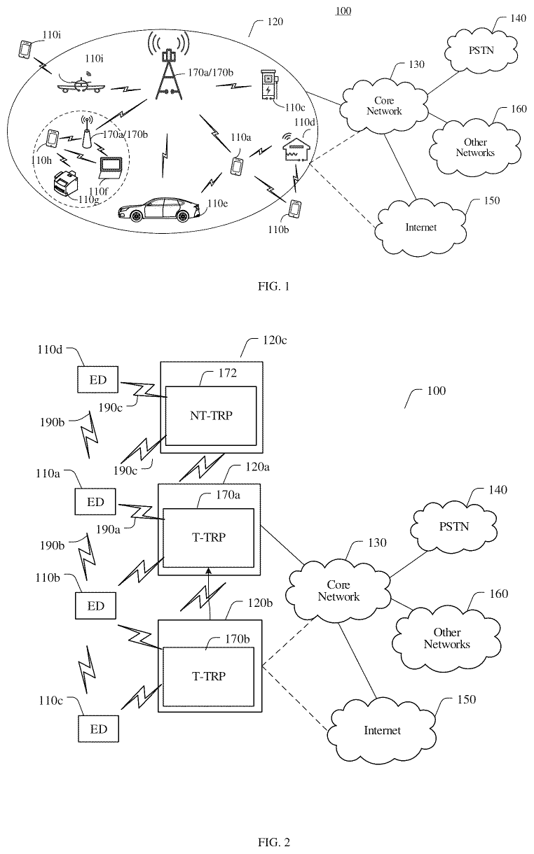

FIG. 1 is a schematic structural diagram of an example communication system.

Referring to FIG. 1, as an illustrative example without limitation, a simplified schematic illustration of a communication system is provided. A communication system 100 includes a radio access network 120. The radio access network 120 may be a next generation (e.g., 6G or later) radio access network, or a legacy (e.g., 5G, 4G, 3G or 2G) radio access network. One or more communication electric device (ED) 110a-120j (generically referred to as 110) may be interconnected to one another or connected to one or more network nodes (170a, 170 b, generically referred to as 170) in the radio access network 120. A core network 130 may be a part of the communication system and may be dependent or independent of the radio access technology used in the communication system 100. Also, the communication system 100 includes a public switched telephone network (PSTN) 140, the internet 150, and other networks 160.

FIG. 2 is a schematic structural diagram of another example communication system.

In general, a communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120 c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190 a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet protocol (IP), transmission control protocol (TCP), and user datagram protocol (UDP). EDs 110a 110b, and 110c may be multimode devices capable of operation according to multiple radio access technologies, and incorporate multiple transceivers necessary to support such.

The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a personal communications service (PCS) phone, a session initiation protocol phone, a wireless local loop (WLL) station, a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the foregoing devices, among other possibilities. Future generation EDs 110 may be referred to using other terms. The base station 170a and 170b is a T-TRP and will hereafter be referred to as T-TRP 170. A NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one or more of: connection availability and connection necessity.

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay nodes, donor nodes, or the like, or combinations thereof. The T-TRP 170 may refer to the foregoing devices or apparatus (e.g., communication module, modem, or chip) in the foregoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g., through coordinated multipoint transmissions.

The NT-TRP 172 may be known by other names in some implementations, such as a non-terrestrial node, a non-terrestrial network device, or a non-terrestrial base station.

Artificial intelligence (AI) technologies can be applied in communication, including artificial intelligence or machine learning (AI/ML) based communication in the physical layer and/or AI/ML based communication in the higher layer, such as medium access control (MAC) layer. For example, in the physical layer, the AI/ML based communication may aim to optimize component design and/or improve the algorithm performance. For example, AI/ML may be applied in relation to the implementation of channel coding, channel modelling, channel estimation, channel decoding, modulation, demodulation, multiple-input multiple-output (MIMO), waveform, multiple access, physical layer element parameter optimization and update, beam forming, tracking, sensing, and/or positioning, etc. For the MAC layer, the AI/ML based communication may aim to utilize the AI/ML capability for learning, prediction, and/or making decisions to solve a complicated optimization problem with possible better strategy and/or optimal solution, e.g., to optimize the functionality in the MAC layer. For example, AI/ML may be applied to implement: intelligent transmission and reception point (TRP) management, intelligent beam management, intelligent channel resource allocation, intelligent power control, intelligent spectrum utilization, intelligent modulation and coding scheme (MCS), intelligent hybrid automatic repeat request (HARQ) strategy, intelligent transmit/receive (Tx/Rx) mode adaption, etc.

In order to facilitate understanding of the embodiments of the present application, terms related to AI/ML that may be involved in the embodiments of the present application are described below.

### (1) Data Collection

Data is a very important component for AI/ML techniques. Data collection is a process of collecting data by the network nodes, management entity, or UE for the purpose of AI/ML model training, data analytics, and inference.

### (2) AI/ML Model Training

AI/ML model training is a process to train an AI/ML Model by learning the input/output relationship in a data driven manner and obtaining the trained AI/ML Model for inference.

### (3) AI/ML Model Inference

A process of using a trained AI/ML model to produce a set of outputs based on a set of inputs.

### (4) AI/ML Model Validation

As a sub-process of training, validation is used to evaluate the quality of an AI/ML model using a dataset different from the one used for model training. Validation can help selecting model parameters that generalize beyond the dataset used for model training. The model parameter after training can be adjusted further by the validation process.

### (5) AI/ML Model Testing

Similar to validation, testing is also a sub-process of training, and it is used to evaluate the performance of a final AI/ML model using a dataset different from the one used for model training and validation. Different from AI/ML model validation, testing does not assume subsequent tuning of the model.

### (6) Online Training

Online training means an AI/ML training process where the model being used for inference is typically continuously trained in (near) real-time with the arrival of new training samples.

### (7) Offline Training

Offline training is an AI/ML training process where the model is trained based on the collected dataset, and where the trained model is later used or delivered for inference.

### (8) AI/ML Model Delivery/Transfer

AI/ML model delivery/transfer is a generic term referring to delivery of an AI/ML model from one entity to another entity in any manner. Delivery of an AI/ML model over the air interface includes either parameters of a model structure known at the receiving end or a new model with parameters. Delivery may contain a full model or a partial model.

### (9) Life Cycle Management (LCM)

When the AI/ML model is trained and/or inferred at one device, it is necessary to monitor and manage the whole AI/ML process to guarantee the performance gain obtained by AI/ML technologies. For example, due to the randomness of wireless channels and the mobility of UEs, the propagation environment of wireless signals changes frequently. Nevertheless, it is difficult for an AI/ML model to maintain optimal performance in all scenarios for all the time, and the performance may even deteriorate sharply in some scenarios. Therefore, the lifecycle management (LCM) of AI/ML models is essential for the sustainable operation of AI/ML in the NR air-interface.

Life cycle management covers the whole procedure of AI/ML technologies applied on one or more nodes. In specific, it includes at least one of the following sub-process: data collection, model training, model identification, model registration, model deployment, model configuration, model inference, model selection, model activation, deactivation, model switching, model fallback, model monitoring, model update, model transfer/delivery and UE capability report.

Model monitoring can be based on inference accuracy, including metrics related to intermediate key performance indicators (KPIs), and it can also be based on system performance, including metrics related to system performance KPIs, e.g., accuracy and relevance, overhead, complexity (computation and memory cost), latency (timeliness of monitoring result, from model failure to action) and power consumption. Moreover, data distribution may shift after deployment due to environmental changes, and thus the model based on input or output data distribution should also be considered.

### (10) Supervised Learning

The goal of supervised learning algorithms is to train a model that maps feature vectors (inputs) to labels (output), based on the training data which includes the example feature-label pairs. The supervised learning can analyze the training data and produce an inferred function, which can be used for mapping the inference data.

### (11) Federated Learning (FL)

Federated learning is a machine learning technique that is used to train an AI/ML model by a central node (e.g., server) and a plurality of decentralized edge nodes (e.g., UEs, next Generation NodeBs, “gNBs”). The central node can also be called the central device. The edge nodes can also be called worker or worker devices. The central device is connected to the worker devices.

According to the wireless FL technique, a central node may provide, to an edge node, a set of model parameters (e.g., weights, biases, gradients) that describe a global AI/ML model. The edge node may initialize a local AI/ML model with the received global AI/ML model parameters. The edge node may then train the local AI/ML model using local data samples to, thereby, produce a trained local AI/ML model. The edge node may then provide, to the central node, a set of AI/ML model parameters that describe the local AI/ML model.

Upon receiving, from a plurality of edge nodes, a plurality of sets of AI/ML model parameters that describe respective local AI/ML models at the plurality of edge nodes, the central node may aggregate the local AI/ML model parameters reported from the plurality of edge nodes and, based on such aggregation, update the global AI/ML model. A subsequent iteration progresses much like the first iteration. The central node may transmit the aggregated global model to a plurality of edge nodes. The above procedure is performed multiple iterations until the global AI/ML model is considered to be finalized, for example, the AI/ML model is converged or the training stopping conditions are satisfied.

The wireless FL technique does not involve the exchange of local data samples. Indeed, the local data samples remain at respective edge nodes.

AI-based algorithms have been introduced into wireless communications to solve a number of wireless problems such as channel estimation, scheduling, CSI compression (from UE to BS), beamforming for MIMO, localization, and so on. AI algorithms are a data-driven approach to tuning some predefined architectures by a set of data samples called training data sets.

Neural networks are a typical way to implement AI algorithms. Deep neural network (DNN) is taken as an example, the DNN can be trained with the training data sets to obtain a model for inference. Recent AI trains DNN architectures by setting up neurons with stochastic gradient descent (SGD) algorithms. For example, DNN includes CNN, RNN, transformers, and the like.

A communication system includes a plurality of connected devices. For example, a device may be a BS or UE. For example, the communication system may be the communication system 100 in FIG. 1 or FIG. 2, and the devices can be the network elements shown in FIG. 1 or FIG. 2.

FIG. 3 is a schematic structural diagram of a device according to an embodiment of the present application. As shown in FIG. 3, the device may include at least one of sensing module, communication module, or AI module. The sensing module may be configured to sense and collect signals and/or data. The communication module may be configured to transmit and receive signals and/or data. The AI module may be configured to train and/or reason the AI implementations.

In order to facilitate understanding of the embodiment of the present application, DNN is taken as an example to illustrate an AI implementation in an embodiment of the present application.

An exemplary AI implementation is DNN-based in two cycles: a training cycle and an inference cycle. The training cycle may also be called the learning cycle. The inference cycle may also be called the reasoning circle.

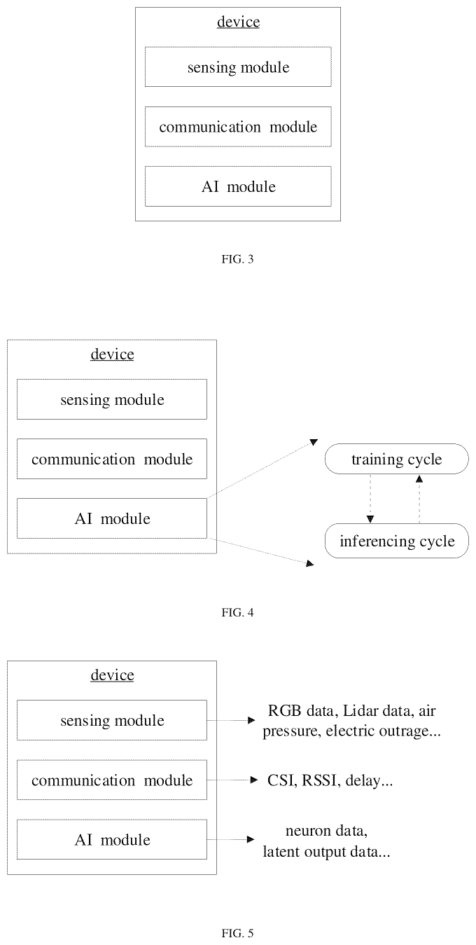

FIG. 4 is a schematic diagram of a device in two cycles according to an embodiment of the present application.

As an example, during an inference cycle, the AI module of the device may perform one inference or a series of inferences with one or more DNNs to fulfill one or more tasks, where the sensing module of the device may generate signals and/or data and the communication module of the device may receive the signals and/or data from other device or devices. For example, the inputs of the one or more DNNs may be the signals and/or data generated by the sensing module of the device, and/or the signals and/or data received by the communication module of the device. After the AI module of the device finishes inferencing, the communication module of the device may transmit the inferencing results to other device or devices.

As another example, during a training cycle, the AI module of the device may train one or more DNNs, where the sensing module of the device may generate signals and/or data and the communication module of the device may receive the signals and/or data from other device or devices. For example, the training data of the one or more DNNs may be the signals and/or data generated by the sensing module of the device, and/or the signals and/or data received by the communication module of the device. During and/or after the AI module finishes training, the communication module of the device may transmit the training results to other device or devices.

The AI implementations may either switch between the two cycles or stay in the two cycles simultaneously.

For example, the AI module of the device may train a DNN during the training cycle. And at the end of the training cycle, the AI implementation switches to the inference cycle, which means the AI module performs inference on that trained DNN. At the end of the inference cycle the AI implementation switches to the training cycle again, and so on.

For another example, the AI module of the device may train a second DNN but still perform inference on a first DNN.

The device mentioned above is merely an example, and the way in which the modules are divided and the number of modules in FIG. 3 and FIG. 4 do not constitute any limitation to the embodiments of the present application. For example, a communication module may be replaced by two modules, i.e., a transmitting module and a receiving module. The transmitting module may be configured to transmit signals and/or data, and the receiving module may be configured to receive signals and/or data. For another example, the sensing module and the communication module may be integrated as one module. For another example, the device may also include a processing module. The processing module may be configured to process signals and/or data. For another example, the device may not include the AI module. For another example, the AI module may only be configured to reason the AI implementation, or the AI module only stays in the inference cycle.

Wireless systems may support AI in both learning and inferencing cycles for generalization and interconnections.

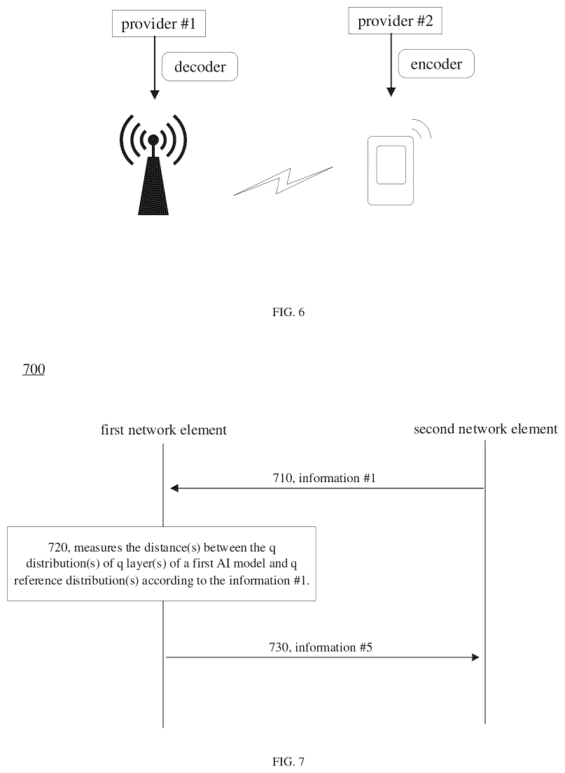

FIG. 5 shows example local data of a device. The local data of a device may include at least one of the following: local sensing data provided by the sensing module of the device, local channel data provided by the communication module of the device, local AI model data provided by the AI module of the device, or local latent output data provided by the AI module of the device. The local channel data is based on the measurement results of the channel. The local channel data can also be considered as sensing results. Thus, the local channel data can be considered as provided by the communication modules or sensing module.

For example, as shown in FIG. 5, the local sensing data may include at least one of RGB data, Lidar data, temperature, air pressure, or electric outage.

For example, as shown in FIG. 5, the local channel data may include at least one of channel state information (CSI), received signal strength indication (RSSI), or delay.

The local AI model data can also be referred to as neuron data. For example, as shown in FIG. 5, the local AI model data may include at least one of the following: part or all of the neurons in the local AI model(s) deployed on the device or part or all of gradients of the local AI model(s) deployed on the device. Neurons can be considered as functions including weights.

For example, as shown in FIG. 5, the local latent output data may include one or more latent outputs of the local AI model(s) deployed on the device.

A device may receive the local data of one or more other devices. As an example, the data received by the communication module of the device may include at least one of sensing data of one or more other devices, channel data of one or more other devices, AI model data of one or more other devices, or latent output data of one or more other devices.

For example, the data received by the communication module of device #A may include channel data of device #B and device #C, and AI model data of device #C. The channel data of device #B and device #C refer to the local channel data of device #B and the local channel data of device #C. The AI model data of device #C refers to the local AI model data of device #C. Device #A, device #B, and device #C are different devices.

For example, sensing data received by the communication module may include at least one of RGB data, Lidar data, temperature, air pressure, or electric outage.

For example, channel data received by the communication module may include at least one of CSI, RSSI, or delay.

For example, AI model data received by the communication module may include at least one of part or all of the neurons in the AI model(s), or part or all of gradients of the AI model(s).

For example, latent output data received by the communication module may include one or more latent outputs of the AI model(s).

During the training cycle, the AI module of a device may work in a single user mode or cooperative mode.

In the single user mode, the AI module of a device may train the one or more local AI models with the local data of the device.

In the cooperative mode, the AI module of a device may train the one or more local AI models with the data received from the communication module of the device.

For example, the data received from the communication module of the device may be used by the AI module to train the local AI model(s) in the following ways.

Alternative #1: the sensing data received by the communication module of the device may be accumulated into one training data set for training the local AI model(s).

Alternative #2: the channel data received by the communication module of the device may be accumulated into one training data set for training the local AI model(s).

Alternative #3: part or all of the neurons in the local AI model(s) may be set based on the AI model data received by the communication module of the device. For example, in a federated learning mode, neurons of an AI model on one device may be set based on the neurons or gradients of the AI model(s) on other device(s). Or, the gradients that the communication module of the device received may be used to update the neurons in the local AI model(s).

Alternative #4: the latent outputs received by the communication module of the device may be inputted to its local AI model(s). For example, when device #A and device #B work together to train a DNN, the device #A trains the first part of the DNN and the device #B trains the second part of the DNN. The device #A's communication module transmits the latent output of the first part of the DNN to the device #B. The device #B receives the latent output of the first part and inputs the latent output to the second part of the DNN.

In addition, the local data of a device and the data received by the communication module of the device can be used together to train the local AI model(s).

For example, the local data of a device and the data received by the communication module of the device can be used by the AI module to train the local AI model(s) in the following ways.

Alternative #1: the local sensing data provided by the sensing module of the device and the sensing data received by the communication module of the device may be mixed into one training data set for training the local AI model(s).

Alternative #2: the local channel data provided by the sensing module of the device and the channel data received by the communication module of the device may be mixed into one training data set for training the local AI model(s).

Alternative #3: part or all of the neurons in the local AI model(s) possessed by the AI module of the device and the corresponding neurons received by the communication module of the device may be averaged as the neurons in the updated local AI model(s). Or, part or all of the gradients of the local AI model(s) possessed by the AI module of the device and the corresponding gradients received by the communication module of the device may be used to update the neurons in the local AI model(s).

Alternative #4: the local latent outputs possessed by the AI module of the device and the latent outputs received by the communication module of the device may be averaged and inputted to its DNN(s).

Whether the AI model deployed on a device can work is crucial for communication quality.

In wireless communication, AI models deployed on different devices may need to work together. Dual sided model is taken as an example. Dual sided model may be in a form of AE, whose encoding DNN is on transmitter side and decoding DNN on receiver side. It is likely that the encoding DNN and decoding DNN are trained and provided by different providers. Moreover, it is hard for AI providers to open their DNN models. This may result in the AI models not working together.

FIG. 6 is a schematic diagram of an example scenario.

As shown in FIG. 6, an encoder deployed on UE and a decoder deployed on BS need to work together. However, the encoder and the decoder may be trained independently by different providers, e.g., provider #1 and provider #2 in FIG. 6, which may affect their interconnection.

The embodiment of the present application provides a communication method that can detect whether an AI model can work by the distance between the output distribution(s) of layer(s) of the AI model and the corresponding reference distribution(s), thereby improving the communication performance.

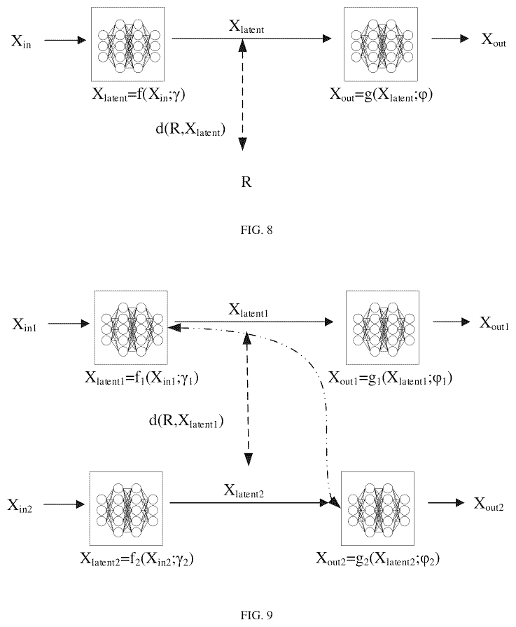

FIG. 7 is a schematic flowchart of a communication method provided by the embodiments of the present application.

As shown in FIG. 7, method 700 includes the following steps.

Step 710, a first network element receives information #1 from a second network element.

Step 720, the first network element measures the distance(s) between the q distribution(s) of q layer(s) of a first AI model in an inference cycle and q reference distribution(s) according to the information #1. q is a positive integer.

The q reference distribution(s) corresponds to the q layer(s) of the first AI model. One reference distribution corresponds to one layer, which may be understood as the reference distribution corresponds to the output of the layer.

The q reference distribution(s) can be referred to as the reference distribution(s) of the q layer(s).

The q layer(s) includes at least one latent layer. Comparing the distribution divergence over more than one latent layer would provide more reliable measurement than over just one latent layer.

A distribution of a layer may refer to the distribution of its outputs.

For the convenience of description, the embodiment of the present application takes q=1 as an example to explain method 700. In this case, in step 720, the first network element may measure the distance between the distribution of a latent layer of the first AI model and a reference distribution according to the information #1.

For example, the first network element may be the device in FIG. 3. The communication module of the first network element may receive the information #1. The AI module of the first network element may perform step 720.

For example, the first network element may be a terminal device or a network device.

For example, the second network element may be the device in FIG. 3. The communication module of the second network element may transmit the information #1.

For example, the second network element may be a network device or a terminal device.

The first AI model can be a neural network model, such as a deep neural network (DNN) model.

During the inference cycle, the AI module of a device may work in cooperative mode. The device may measure the distance.

A distribution can be represented in multiple forms. Taking the reference distribution as an example, the following describes examples of the distribution representations.

In some embodiments, a reference distribution may be in a form of the parameterized standard distribution R R(λ₁,λ₂, . . . ) such as normal distribution, Poisson distribution, Rayleigh distribution, and so on. R represents the reference distribution. R(λ₁,λ₂, . . . ) represents the parameterized standard distribution. λ₁ and λ₂ represent the statistic parameters used to describe the parameterized standard distribution.

In some embodiments, a reference distribution may be in a form of a combination of multiple parameterized standard distributions.

For example, a reference distribution may be in a form of a linear combination of multiple Gaussian distributions.

In some embodiments, a reference distribution may be in a form of a plurality of reference data samples, such as R: [r₁,r₂, . . . , r_{M}]. r₁ is the first reference sample used to represent the reference distribution, r₂ is the second reference sample used to represent the reference distribution, and so on. M is the number of reference data samples used to represent the reference distribution.

The reference distribution represented by one or more standard distributions saves much more radio resources than the reference distribution represented by a plurality of reference data samples.

Exemplary, the distribution of the latent layer can also be represented in a similar form as mentioned above.

The second network element may send the information #1 in broadcast, multicast, or unicast way.

The following describes some examples of the information #1.

In some embodiments, the information #1 may be used to trigger the measurement.

The first network element receives the information #1, and then measures the distance(s).

For example, the information #1 may be used to indicate the first network element to measure the distance.

For another example, the information #1 may be used to indicate the first network element to send the distance.

For another example, the information #1 may be used to indicate the first network element to perform checking.

The distance can be used for performing checking.

Performing checking may include checking whether the first AI model can work with the other AI model(s). For ease of description, the other AI model(s) in the embodiments of the present application can be referred to as the second AI model.

In the embodiment of the application, “checking whether the first AI model can work with the second AI model” can also be replaced by the following description: checking whether the first AI model can work as expected; checking whether the distance meets the expectation; checking whether the distance meets the conditions; checking whether the distance is within the predefined range; checking whether the first AI model meets expectations; checking whether the first AI model is a candidate model matching the second AI model, and so on.

For the convenience of description, the embodiment of the present application mainly takes checking whether two AI models can work together as an example for explanation.

The information #1 may indicate checking whether the first AI model can work with the second AI model according to the distance measured in step 720.

In some embodiments, the information #1 may be used to indicate the reference distribution. In this case, the information #1 can be regarded as the second information.

For example, the information #1 may indicate the statistic parameters of the reference distribution.

As mentioned before, a reference distribution may be a parameterized standard distribution or a combination of multiple parameterized standard distributions. The information #1 may indicate the description of the reference distribution by some statistic parameters.

For another example, the information #1 may indicate the reference data samples used to represent the reference distribution.

For another example, the information #1 may indicate the index of the reference distribution.

Exemplarily, there may be multiple candidate reference distributions in the first network element. The information #1 may include the index of the reference distribution within the multiple candidates.

The information #1 can also be in other forms, as long as it can indicate the reference distribution.

In some embodiments, the information #1 may be used to indicate the distribution of the latent layer.

The form of information #1 indicating the distribution of the latent layer can refer to the form of information #1 indicating the reference distribution mentioned earlier, and will not be repeated here.

In some embodiments, the latent layer may be determined by the second network element. The second network element can inform the first network element.

The second network element may send information #2 indicating the latent layer to the first network element.

For example, the information #2 may include an indicator indicating the latent layer.

In some embodiments, the latent layer may be determined by the first network element. The second network element can inform the second network element.

The first network element may send information #3 indicating the latent layer to the second network element.

The form of information #3 may refer to the information #2, and will not be repeated here.

In some embodiments, the latent layer may be predefined.

The distance between the reference distribution and the distribution of the latent layer may be measured with a scoring function.

For example, the scoring function may be based on one of the following: Kullback-Leibler divergence (KL divergence), graph edit distance, Wasserstein distance, or Jensen-Shanon distance (JSD distance).

For example, a scoring function d(R, \hat{R}) is used to measure the distance between the reference distribution R and the latent layer output distribution \hat{R}.

In some embodiments, the scoring function may be determined by the second network element.

Method 700 may also include the following step.

The first network element may receive information #4 (an example of the third information) indicating the scoring function from the second network element.

For example, the information #4 may include the scoring function.

For another example, the information #4 may include the index of the scoring function.

In some embodiments, the scoring function may be determined by the first network element.

The first network element may get the scoring function through other methods. For example, the scoring function may be predefined.

FIG. 8 is a schematic diagram of a distance between a reference distribution and the distribution of one latent layer output.

As shown in FIG. 8, the AE includes an encoder f( ) and a decoder g( ). The input to the AE is the input to the encoder. The output of the encoder is the input to the decoder. The output from the AE is the output from the decoder. The relationship between the input and output of the encoder can be represented as Xₗₐₜₑₙₜ=f (X¿, γ). γ represents parameters of the encoder. The relationship between the input and output of the decoder can be represented as Xₒᵤₜ=g(Xₗₐₜₑₙₜ, φ). φ represents parameters of the decoder.

The output of the encoder can be considered as a latent layer output of the AE. The distance between the reference distribution and the distribution of the latent layer output can be denoted as d(R, Xₗₐₜₑₙₜ). d( ) represents the scoring function used to measure the difference between the reference distribution R and the latent layer output Xₗₐₜₑₙₜ.

The above is only an example scenario and does not constitute a limitation on the technical solutions of the present application embodiment. For example, the first AI model can also be other models.

In some scenarios, a plurality of AI models need to work together, where output of a latent layer of one AI model may be input of a latent layer of another AI model. These AI models may be trained independently by different providers.

The distributions of the latent layers of two AI models (such as the first AI model and the second AI model) can be used to check whether the two AI models can work together. In other words, the distributions of the latent layers of two AI models can be used to check the interconnection or cross consistency of the AI models.

The closer the distribution of the latent layer in an AI model (such as the first AI model) is to that of the latent layer in another AI model (such as the second AI model), the greater the likelihood that the two AI models can work together. In other words, the smaller the distance between the distribution of the latent layer in an AI model and the distribution of the latent layer in another AI model, the greater the likelihood that the two AI models can work together.

For example, for two AI models with the same structure (such as the first AI model and the second AI model), the smaller the distance between the distribution of the m-th latent layer in the first AI model and the distribution of the m-th latent layer in the second AI model, the higher the possibility that the two AI models can work together, that is, the output of the m-th latent layer of the first AI model can be used as the input of the (m+1)-th latent layer of the second AI model. FIG. 8 is taken as an example; the output of the latent layer can be the output of the encoder.

In some embodiments, for two AI models that need to work together, the reference distribution may be the distribution of the latent layer in one of the AI models. The distance between the reference distribution and the distribution of the latent layer of another AI model can be used to check interconnection.

For example, there are two AI models, such as the first AI model and the second AI model, that need to work together. The reference distribution can be the distribution of the m-th latent layer of the first AI model. In this case, the smaller the distance between the reference distribution and the distribution of the m-th latent layer of the second AI model, the greater the likelihood that the two AI models can work together.

In some embodiments, for two AI models that need to work together, the distance between the distributions of latent layers of the two AI models and the reference distribution can be used to check interconnection.

For example, there are two AI models, such as AI model #A and AI model #B, that need to work together. The distance between the reference distribution and the distribution of the m-th layer of AI model #A can be called distance #A. The distance between the reference distribution and the distribution of the m-th layer of AI model #B can be called distance #B. In this case, the smaller the difference between the distance #A and the distance #B, the greater the likelihood that the two AI models can work together.

In the embodiments of the present application, the distance between the reference distribution and the distribution of the latent layer can be used to check whether AI models can work together, which is conducive to ensuring the quality of data processing or communication.

The step 710 can be an optional step. For example, the first network element may determine to perform the step 720 by the first network element itself.

Further, optionally, the method may also include: checking whether the first AI model can work with the second AI model by the distance measured in step 720.

The conditions for determining whether the first AI model can work with the second AI model can be referred to in the following text.

For example, the AI module of the first network element may check whether the distance satisfies the condition. If the AI module of the first network element suspects the distance does not meet the conditions, it may decide that the first AI model cannot work with the second AI model.

Further, optionally, the method 700 may also include step 730.

730 □ the first network element sends information #5 (an example of the first information) according to the distance measured in step 720 to the second network element.

The information #5 may be used to indicate the distance measured in step 720.

For example, the communication module of the first network element may send the information #5.

The first network element may send information #5 to other devices.

In some embodiments, the information #5 may include the distance measured by the first network element.

For example, the first network element may report information #5 when the measurement is completed.

Alternatively, the first network element may report information #5 when the first network element determines that the first AI model cannot work with the second AI model.

In some embodiments, the information #5 may indicate other content related to the distance.

For example, there may be multiple ranges. Each range corresponds to a level. The information #5 may indicate the level corresponding to the range to which the distance belongs.

For another example, if the first network element checks whether the first AI model can work with the second AI model, the information #5 may indicate the check result.

If the first network element reports the distance to the second network element, it can also be performed by the second network element to determine whether the first AI model can work with the second AI model with the distance measured by the first network element.

The above is explained using q=1 as an example. In the case of q>1, the corresponding content is adjusted adaptively.

The following are some examples for the case where q>1.

For example, in step 730, the first network element sends information #5 according to the distances between q reference distributions and distributions of q layers of the first AI model in an inference cycle to the second network element.

For another example, the distances between q reference distributions and distributions of q layers of the first AI model can be used to check whether the first AI model can work with the second AI model.

For another example, the q reference distributions may be the distributions of the q layers of the second AI model. The distances between the distributions of q layers of the first AI model and the distributions of q layers of the second AI model can be used to check interconnection.

For another example, the q reference distributions may be q common reference distributions. The distances between the distributions of q layers of the two AI models and the q common reference distributions can be used to check interconnection.

For another example, the second information may be used to indicate the q reference distributions.

For another example, the third information may indicate the one or more scoring function(s), where the one or more scoring function(s) is used to measure the distances between the q reference distributions and the distributions of the q layers of the first AI model. The one or more scoring function(s) may be q scoring functions.

Further, optionally, if the first AI model and the second AI model cannot work together, the first AI model and/or the second AI model may be replaced. For example, the current first AI model may be switched to other AI models. Alternatively, the current first AI model may be replaced by a non-AI model.

The switched model can be configured by the second network element.

Alternatively, the switched model can also be determined by the first network element and notified to the second network element.

The following are some example embodiments for method 700. In the following examples, AI model #1 (an example of the first AI model) and AI model #2 (an example of the second AI model) that need to work together are deployed on device #1 and device #2, respectively.

Dual sided model is taken as an example. An encoder and a decoder deployed on different devices may need to work together. The encoder can be deployed on the transmitter side and the decoder can be deployed on the receiver side. The transmitter side is an encoding device. The receiver side is a decoding device. The encoder of the encoding device may output to the decoder of the decoding device. The method 700 may be applied to check whether the encoder and the decoder deployed on different devices can work together. The following takes a DNN-based autoencoder as an example. The encoder can be an encoding DNN and the decoder can be a decoding DNN. AI model #1 can be AE #1 and AI model #2 can be AE #2.

For example, the device #1 may include the modules shown in FIG. 3, where the sensing module may be used to collect the local data, AI module may be used to perform inference on its local data with encoding DNN #1 in the AE #1, and communication module may be used to receive signals and/or data and transmit signals and/or data. The device #2 may include the modules shown in FIG. 3, where the sensing module may be used to collect the local data, AI module may be used to perform inference on the data received from the encoding DNN on other devices with decoding DNN #2 in the AE #2, and communication module may be used to receive signals and/or data and transmit signals and/or data.

The encoding DNN on the device #1 need to work with the decoding DNN on the device #2. Method 700 can be used to determine whether the models on two devices can work together.

The above only takes the deployment of encoding DNN on device #1 and decoding DNN on device #2 as an example. In the following example embodiments, encoding DNN can also be deployed on device #2 and decoding DNN can also be deployed on device #1. The present application does not limit this.

### Example 1

S1-1, the device #1 measures the distance between the reference distribution and the distribution of a latent layer in the AI model #1.

In example 1, the device #1 can be the first network element and the device #2 can be the second network element.

The consistency check can be done periodically or non-periodically.

For example, the consistency check can be triggered by one of the two devices.

In some embodiments, the reference distribution can be the distribution of the same latent layer in the AI model #2. Before S1-1, device #1 may receive information #1 indicating the reference distribution from device #2.

The conditions based on the distance between the reference distribution and the distribution of the latent layer for determining whether the AI models can work together can be set as needed.

For example, if the distance between the reference distribution and the distribution of the latent layer is less than or equal to a threshold, the AI model #1 deployed on the device #1 may be able to work with the AI model #2 deployed on device #2. Otherwise, AI model #1 and AI model #2 cannot work together.

The threshold can be determined by device #2 or device #1, or predefined.

In the case of q>1, different layers can correspond to the same threshold or different thresholds.

In one possible implementation, the device #1 may check the interconnection according to the distance measured in S1-1.

Further, optionally, the device #1 may send information #5 to the device #2. The device #2 may determine interconnection according to the information #5.

Exemplarily, the device #1 can inform the device #2 of the check result.

For example, the information #5 may include the check result of the device #1. Alternatively, the device #1 may send information #5 when determining that the AI models can work together. Alternatively, the device #1 may send information #5 when determining that the AI models cannot work together.

Exemplarily, the device #1 can inform the device #2 of the distance.

For example, the information #5 may include the distance measured by the device #1. The device #2 may check the interconnection according to the distance.

Exemplarily, the device #1 can inform the device #2 of the level corresponding to the distance.

For example, the information #5 may include the level. The device #2 may check the interconnection according to the level.

In one possible implementation, the device #1 may not check the interconnection. In this case, the device #1 sends information #5 to the device #2. The device #2 may check interconnection according to the information #5.

Exemplarily, the device #1 can inform the device #2 of the distance.

For example, the information #5 may include the distance measured by the device #1. The device #2 may check the interconnection according to the distance.

Exemplarily, the device #1 can inform the device #2 of the level corresponding to the distance.

For example, the information #5 may include the level. The device #2 may check the interconnection according to the level.

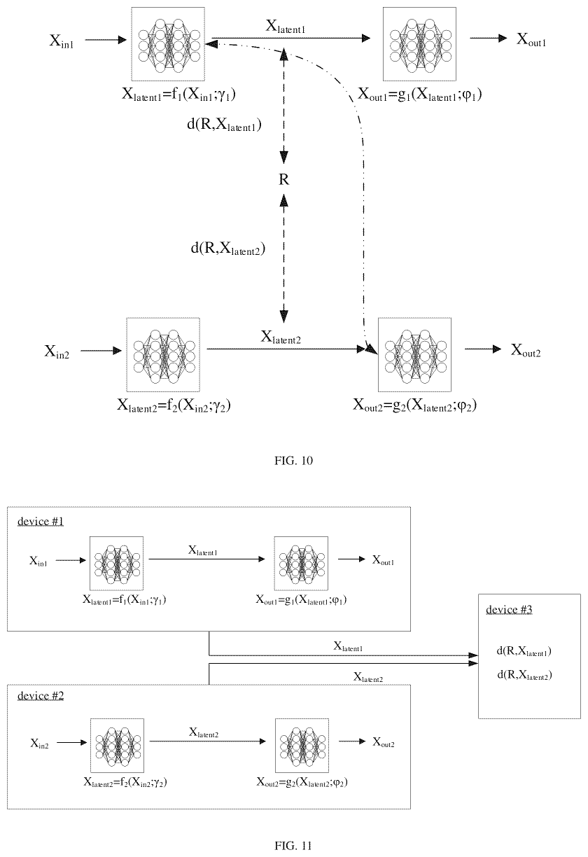

FIG. 9 shows a schematic diagram of an example interconnection check.

f₁( ) represents the encoder of the AE #1 in device #1. γ₁ represents parameters of the encoder f₁( ). g₁( ) represents the decoder of the AE #1, and φ₁ represents parameters of the decoder g₁( ). The output of the encoder is the input of the decoder. X_{¿1} represents the input to the AE #1 and the Xₒᵤₜ₁ represents the output from the AE #1.

f₂( ) represents the encoder of the autoencoder #2 in device #2. γ₂ represents parameters of the encoder f₂( ). g₂( ) represents the decoder of the autoencoder #2, and φ₂ represents parameters of the decoder g₂( ). The output of the encoder is the input of the decoder. X_{¿2} represents the input to the AE #2 and the Xₒᵤₜ₂ represents the output from the AE #2.

Method 700 can be used to check whether AE #1 and AE #2 can work together.

For example, method 700 can be used to check whether the encoder #1 can work with decoder #2.

Alternatively, method 700 can be used to check whether the encoder #2 can work with decoder #1.

The device #2 may send a reference distribution R to the device #1. The reference distribution R can be the Xₗₐₜₑₙₜ₂, that is the output of the encoder in the autoencoder #2.

The AI module of the device #1 measures the distance between the reference distribution and the distribution of the output of the encoder in the autoencoder #1 Xₗₐₜₑₙₜ₁, that is d(R, Xₗₐₜₑₙₜ₁). d( ) is the scoring function used to measure the distance between two distributions.

The device #1 may check whether the encoder #1 can work with decoder #2 according to the distance.

Further, the communication module of the device #1 may transmit the check result to the device #2.

Alternatively, the device #1 may send the distance to the device #2. The device #2 may receive the distance and check whether the encoder #1 can work with decoder #2 according to the distance.

Further, the communication module of the device #2 may transmit the check result to the device #1.

In some embodiments, the reference distribution can be a common distribution.

In this case, the method further includes step S1-2.

S1-2, device #2 measures the distance between the reference distribution and the distribution of the latent layer in the AI model #2.

For example, the reference distribution may be predefined. Before S1-1, device #1 may receive information #1 which is used to trigger the measurement from device #2.

Alternatively, the reference distribution may be determined by the device #2. Before S1-1, device #1 may receive information #1 indicating the reference distribution from the device #2.

Alternatively, the reference distribution may be determined by the device #1. Before S1-1, device #1 may receive information #1 indicating the reference distribution from the device #2. Before S1-2, device #1 may send information indicating the reference distribution to the device #2.

The conditions based on the distance between the reference distribution and the distribution of the latent layer for determining whether the AI models can work together can be set as needed.

For ease of description, the distance between the distribution of the latent layer of AI model #1 and the reference distribution is called distance #1, and the distance between the distribution of the latent layer of AI model #2 and the reference distribution is called distance #2.

For example, if the difference between distance #1 and distance #2 is less than or equal to a threshold, the AI model #1 deployed on the device #1 may be able to work with the AI model #2 deployed on device #2. Otherwise, AI model #1 and AI model #2 cannot work together.

The threshold may be determined by device #2 or device #1, or predefined.

In the case of q>1, different layers can correspond to the same threshold or different thresholds.

For another example, there may be multiple ranges. If distance #1 and distance #2 belong to the same range, the AI model #1 deployed on the device #1 may be able to work with the AI model #2 deployed on device #2. Otherwise, AI model #1 and AI model #2 cannot work together.

Each range may correspond to a level. In this case, if distance #1 and distance #2 correspond to the same level, the AI model #1 deployed on the device #1 may be able to work with the AI model #2 deployed on device #2.

In one possible implementation, the device #1 may check the interconnection.

For example, the device #1 may receive the distance #2 from device #2, and check the interconnection according to the distance #1 and distance #2.

For another example, the device #1 may receive the level corresponding to the distance #2 from device #2, and check the interconnection according to the level corresponding to the distance #1 and the level corresponding to the distance #2.

Further, optionally, the device #1 may send information #5 to the device #2. The device #2 may determine interconnection according to the information #5.

Exemplarily, the device #1 can inform the device #2 of the check result.

For example, the information #5 may include the check result of the device #1. Alternatively, the device #1 may send information #5 when determining that the AI models can work together. Alternatively, the device #1 may send information #5 when determining that the AI models cannot work together.

In one possible implementation, the device #1 may not check the interconnection. In this case, the device #1 sends information #5 to the device #2. The device #2 may check interconnection according to the information #5.

Exemplarily, the device #1 can inform the device #2 of the distance #1.

For example, the information #5 may include the distance #1 measured by the device #1. The device #2 may check the interconnection according to the distance #1 and distance #2.

Exemplarily, the device #1 can inform the device #2 of the level corresponding to the distance #1.

For example, the information #5 may include the level corresponding to the distance #1. The device #2 may check the interconnection according to the level corresponding to the distance #1 and the level corresponding to the distance #2.

FIG. 10 shows a schematic diagram of an example interconnection check.

The device #2 may send a reference distribution R to the device #1. The reference distribution R can be a common reference distribution.

The AI module of the device #1 measures the distance between the reference distribution and the distribution of the output of the encoder in the autoencoder #1 Xₗₐₜₑₙₜ₁, that is, d(R, Xₗₐₜₑₙₜ₁). The AI module of the device #2 measures the distance between the reference distribution and the distribution of the output of the encoder in the autoencoder #2 Xₗₐₜₑₙₜ₂, that is d(R, Xₗₐₜₑₙₜ₂). d( ) is the scoring function used to measure the distance between two distributions.

The device #1 may receive d(R, Xₗₐₜₑₙₜ₂) and check whether the encoder #1 can work with decoder #2 according to d(R, Xₗₐₜₑₙₜ₁) and d(R, Xₗₐₜₑₙₜ₂).

Further, the communication module of the device #1 may transmit the check result to the device #2.

Alternatively, the device #1 may send d(R, Xₗₐₜₑₙₜ₁) to the device #2. The device #2 may check whether the encoder #1 can work with decoder #2 according to d(R, Xₗₐₜₑₙₜ₁) and d(R, Xₗₐₜₑₙₜ₂).

Further, the communication module of the device #2 may transmit the check result to the device #1.

### Example 2

S2-1, device #3 receives information indicating the distribution of the latent layer in the AI model #1 from device #1.

S2-2, device #3 receives information indicating the distribution of the latent layer in the AI model #2 from device #2.

S2-3, device #3 measures the distance between the reference distribution and the distribution of the latent layer in the AI model #1.

In example 2, the device #3 can be the first network element. The device #1 and the device #2 can be the second network element.

The consistency check can be done periodically or non-periodically.

For example, the consistency check can be triggered by one of the three devices.

In some embodiments, the reference distribution can be the distribution of the latent layer in the AI model #2. In this case, the device #3 measures the distance between the distribution of the latent layer in the AI model #2 and the distribution of the latent layer in the AI model #1.

The information indicating the distribution of the latent layer in the AI model #1 can be regarded as information #1. The information indicating the distribution of the latent layer in the AI model #2 can be regarded as information #1.

The conditions used to determine whether the AI model can work together can refer to Example 1.

In one possible implementation, the device #3 may check the interconnection according to the distance measured in S2-3.

Further, optionally, the device #3 may send information #5 to the device #1 and device #2. The device #1 and device #2 may determine interconnection according to the information #5.

The description of information #5 can refer to Example 1. Simply device #1 is replaced with device #3 and device #2 is replaced with device #1 and device #2.

In one possible implementation, the device #3 may not check the interconnection. In this case, the device #3 sends information #5 to the device #2 and device #1. The device #2 and device #1 may check interconnection according to the information #5.

The description of information #5 can refer to Example 1. Simply device #1 is replaced with device #3 and device #2 is replaced with device #1 and device #2.

In some embodiments, the reference distribution can be a common distribution.

In this case, the method further includes step S2-4.

S2-4, device #3 measures the distance between the reference distribution and the distribution of the latent layer in the AI model #2.

For example, the reference distribution may be predefined.

Alternatively, the reference distribution may be determined by the device #2 or device #1. The device #3 may receive information #1 indicating the reference distribution from the device #2 or device #1.

Alternatively, the reference distribution may be determined by the device #3.

The conditions used to determine whether the AI model can work together can refer to Example 1.

In one possible implementation, the device #3 may check the interconnection.

Further, optionally, the device #3 may send information #5 to the device #2 and device #1. The device #1 and device #2 may determine interconnection according to the information #5.

The description of information #5 can refer to Example 1. Simply device #1 is replaced with device #3 and device #2 is replaced with device #1 and device #2.

In one possible implementation, the device #3 may not check the interconnection. The interconnection check may be performed by the device #1 and/or device #2. In this case, the device #3 sends information #5 to the device #1 and/or device #2. The device #1 and/or device #2 may check interconnection according to the information #5.

The description of information #5 can refer to Example 1. Simply device #1 is replaced with device #3 and device #2 is replaced with device #1 and device #2.

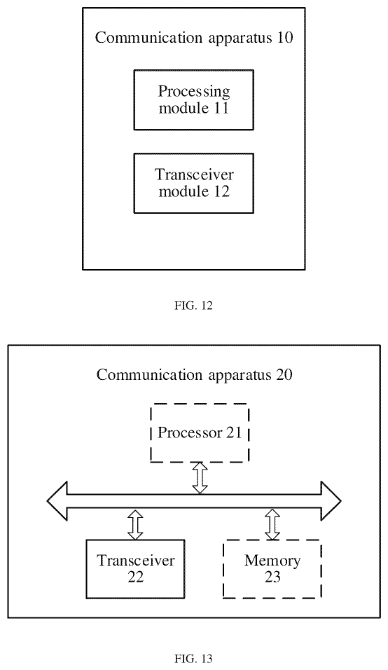

FIG. 11 shows a schematic diagram of an example interconnection check.

For example, as shown in FIG. 11, the device #1 sends the distribution of the output of the encoder in the autoencoder #1 Xₗₐₜₑₙₜ₁ to the device #3, and the device #2 sends the distribution of the output of the encoder in the autoencoder #2 Xₗₐₜₑₙₜ₂ to the device #3.

The AI module of the device #3 measures the distance between the reference distribution and the distribution of the output of the encoder in the autoencoder #1, that is, d(R, Xₗₐₜₑₙₜ₁). The AI module of the device #3 measures the distance between the reference distribution and the distribution of the output of the encoder in the autoencoder #2, that is, d(R, Xₗₐₜₑₙₜ₂). d( ) is the scoring function used to measure the distance between two distributions.

Further, the device #3 may check whether the encoder #1 can work with decoder #2 according to d(R, Xₗₐₜₑₙₜ₁) and d(R, Xₗₐₜₑₙₜ₂).

Further, the communication module of the device #3 may transmit the check result to the device #2 and device #1.

### Example 3

S3-1, device #3 sends information #1 indicating a reference distribution to device #1.

S3-2, device #3 sends information #1 indicating a reference distribution to device #2.

S3-3, device #1 measures the distance between the reference distribution and the distribution of the latent layer in the AI model #1.

S3-4, device #2 measures the distance between the reference distribution and the distribution of the latent layer in the AI model #2.

In example 3, the device #1 and device #2 can be the first network element. Device #3 can be the second network.

The consistency check can be done periodically or non-periodically.

For example, the consistency check can be triggered by one of the three devices.

The reference distribution can be a common distribution.

For example, the reference distribution may be predefined.

Alternatively, the reference distribution may be determined by the device #3.

The conditions used to determine whether the AI models can work together can refer to Example 1.

In one possible implementation, the device #3 may check the interconnection.

Exemplarily, the device #1 and device #2 can inform the device #3 of the distance #1 and the distance #2.

The device #3 may check the interconnection according to the distance #1 and distance #2.

Exemplarily, the device #1 can inform the device #3 of the level corresponding to the distance #1, and the device #2 can inform the device #3 of the level corresponding to the distance #2.

The device #3 may check the interconnection according to the level corresponding to the distance #1 and the level corresponding to the distance #2.

Further, optionally, the device #3 may send information indicating the check result to device #1 and/or device #2.

The specific description of the steps in the examples mentioned above can refer to method 700 which will not be repeated here.

The above is only an example process of the application of the technical solutions in the present application embodiments to interconnection check. The technical solutions in the present application embodiments can also be implemented in other ways when it is applied to interconnection check, and the related description can refer to method 700, which will not be repeated here.

The process in example-1, example-2 and example-3 are merely examples. For other implementation methods, please refer to method 700.

The communication method according to the embodiments of the present application is described in detail above, and the communication apparatus according to the embodiments of the present application will be described in detail below with reference to FIGS. 12-16.

FIG. 12 is a schematic block diagram of a communication apparatus 10 according to an embodiment of the present application. As shown in FIG. 12, the communication apparatus 10 includes:
a processing module 11, configured to obtain distance(s) between q reference distribution(s) and distribution(s) of q layer(s) of a first AI model in an inference cycle, where the q reference distribution(s) corresponds to the q layer(s), and q is a positive integer; and
a transceiver module 12, configured to send first information according to the distance(s) between the q reference distribution(s) and the distribution(s) of the q layer(s) of the first AI model.

The communication apparatus 10 in this embodiment of the present application may correspond to the first network element in the communication method in the embodiments of the present application described above, and the foregoing management operations and/or functions and other management operations and/or functions of modules of the communication apparatus 10 are intended to implement corresponding steps of the foregoing methods. For brevity, details are not described herein again.

The transceiver module 12 in this embodiment of the present application may be implemented by a transceiver, and the processing module 11 may be implemented by a processor.

As shown in FIG. 13, a communication apparatus 20 may include a transceiver 21. Optionally, the communication apparatus 20 may further include a processor 22 and/or a memory 23. The memory 23 may be configured to store indication information, or may be configured to store code, instructions, and the like that is to be executed by the processor 22.

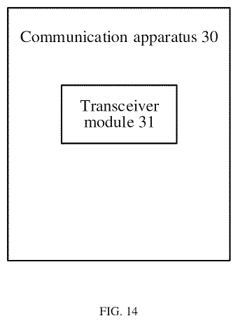

FIG. 14 is a schematic block diagram of a communication apparatus 30 according to an embodiment of the present application. As shown in FIG. 14, the communication apparatus 30 includes:
a transceiver module 31, configured to receive first information related to distance(s) between q reference distribution(s) and distribution(s) of q layer(s) of first AI model in an inference cycle, where the q reference distribution(s) corresponds to the q layer(s), and q is a positive integer.

The communication apparatus 30 in this embodiment of the present application may correspond to the second network element in the communication method in the embodiments of the present application described above, and the management operations and/or functions and other management operations and/or functions of modules of the communication apparatus 30 are intended to implement corresponding steps of the foregoing methods. For brevity, details are not described herein again.

The transceiver module 31 in this embodiment of the present application may be implemented by a transceiver.

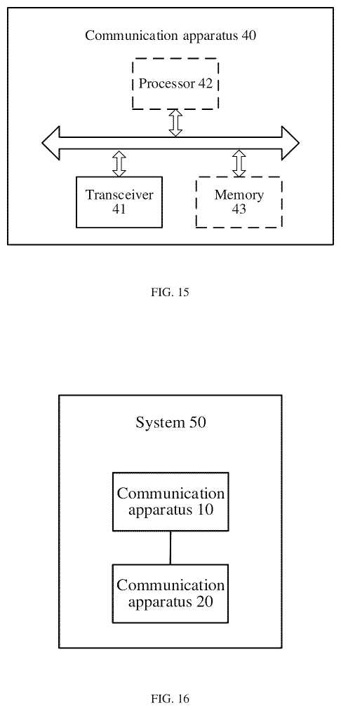

As shown in FIG. 15, a communication apparatus 40 may include a transceiver 41. Optionally, the communication apparatus 40 may further include a processor 42 and/or a memory 43. The memory 43 may be configured to store indication information, or may be configured to store code, instructions, and the like that is to be executed by the processor 42.

The processor 22 or the processor 42 may be an integrated circuit chip and have a signal processing capability. In an embodiment process, steps in the foregoing method embodiments can be implemented by using a hardware-integrated logical circuit in the processor, or by using instructions in the form of software. The processor 22 or the processor 42 may be a general-purpose processor, a digital signal processor (DSP), an application-specific integrated circuit (ASIC), a field programmable gate array (FPGA), or another programmable logic device, a discrete gate or a transistor logic device, or a discrete hardware component. All methods, steps, and logical block diagrams disclosed in this embodiment of the present application may be implemented or performed. The general-purpose processor may be a microprocessor, or the processor may be any conventional processor or the like. Steps of the methods disclosed in the embodiments of the present invention may be directly performed and completed by a hardware decoding processor, or may be performed and completed by using a combination of hardware and software modules in the decoding processor. The software module may be located in a storage medium known in the art, such as a random access memory, a flash memory, a read-only memory, a programmable read-only memory, an electrically erasable programmable memory, or a register. The storage medium is located in the memory, and the processor reads the information in the memory and completes the steps in the foregoing methods in combination with the hardware of the processor.

It may be understood that the memory 23 or the memory 43 in the embodiments of the present invention may be a volatile memory or a non-volatile memory, or may include a volatile memory and a non-volatile memory. The non-volatile memory may be a read-only memory (ROM), a programmable read-only memory (PROM), an erasable programmable read-only memory (EPROM), an electrically erasable programmable read-only memory EEPROM), or a flash memory. The volatile memory may be a random access memory (RAM), and be used as an external cache. Through example but not limitative description, many forms of RAMs may be used, for example, a static random access memory (SRAM), a dynamic random access memory (DRAM), a synchronous dynamic random access memory SDRAM), a double data rate synchronous dynamic random access memory (DDR SDRAM), an enhanced synchronous dynamic random access memory (Enhanced SDRAM, ESDRAM), a synchronous link dynamic random access memory (SLDRAM), and a direct rambus dynamic random access memory (DR RAM). The storage of the system and the method described in this specification aim to include, but are not limited to, these and any other proper storage.

An embodiment of the present application further provides a system. As shown in FIG. 16, a system 50 includes:
the communication apparatus 10 according to the embodiments of the present application and the communication apparatus 20 according to the embodiments of the present application.

An embodiment of the present application further provides a computer storage medium, and the computer storage medium may store a program instruction for executing any of the foregoing methods.

Optionally, the storage medium may be specifically the memory 23 or 43.

A person of ordinary skill in the art will be aware that, in combination with the examples described in the embodiments disclosed in this specification, units and algorithm steps may be implemented by using electronic hardware or a combination of computer software and electronic hardware. Whether the functions are performed by using hardware or software depends on particular applications and design constraint conditions of the technical solutions. A person skilled in the art may use different methods to implement the described functions for each particular application, but it should not be considered that the embodiment goes beyond the scope of the present application.

It would be understood by a person skilled in the art that, for the purpose of convenience and brevity, in a detailed working process of the foregoing system, apparatus, and unit, reference may be made to a corresponding process in the foregoing method embodiments, and details are not described herein again.

In the several embodiments provided in the present application, the disclosed system, apparatus, and method may be implemented in other manners. For example, the described apparatus embodiment is merely an example. For example, the unit division is a logical function division and other methods of division may be used in an actual embodiment. For example, a plurality of units or components may be combined or integrated into another system, or some features may be ignored or not performed. In addition, the displayed or discussed mutual couplings or direct couplings or communication connections may be implemented using various communication interfaces. The indirect couplings or communication connections between the apparatuses or units may be implemented in electronic, mechanical, or other forms.

The units described as separate parts may or may not be physically separate, and parts displayed as units may or may not be physical units, that is, the parts may be located in one unit, or may be distributed among a plurality of network units. Some or all of the units may be selected based on actual requirements to achieve the objectives of the embodiments.

In addition, function units in the embodiments of the present application may be integrated into one processing unit, each of the units may exist alone physically, or two or more units may be integrated into one unit.

When the functions are implemented in the form of a software functional unit and sold or used as an independent product, the functions may be stored in a computer-readable storage medium. The technical solutions of the present application may be implemented in the form of a software product. The software product is stored in a storage medium, and includes several instructions for instructing a computer device (which may be a personal computer, a server, a network device, or the like) to perform all or some of the steps of the methods described in the embodiments of the present application. The foregoing storage medium includes any medium that can store program code, such as a USB flash drive, a removable hard disk, a read-only memory (Read-Only Memory, ROM), a random access memory (Random Access Memory, RAM), a magnetic disk, an optical disc or the like.

The foregoing descriptions are merely specific embodiments of the present application, but are not intended to limit the protection scope of the present application. Any variation or replacement readily figured out by a person skilled in the art within the technical scope disclosed in the present application shall fall within the protection scope of the present application. Therefore, the protection scope of the present application shall be subject to the protection scope of the claims.

1. A method, comprising:
obtaining distance(s) between q reference distribution(s) and distribution(s) of q layer(s) of a first artificial intelligence (AI) model in an inference cycle, wherein the q reference distribution(s) corresponds to the q layer(s) of the first AI model, and q is a positive integer; and
sending first information according to the distance(s) between the q reference distribution(s) and the distribution(s) of the q layer(s) of the first AI model.

2. The method according to claim 1, wherein the q layer(s) comprises one or more latent layers of the first AI model.

3. The method according to claim 2, wherein the distance(s) between the q reference distribution(s) and the distribution(s) of the q layer(s) of the first AI model is configured to check whether the first AI model works with a second AI model.

4. The method according to claim 3, wherein the q reference distribution(s) is of q layer(s) of the second AI model.

5. The method according to claim 3, wherein the distance(s) between the q reference distribution(s) and the distribution(s) of the q layer(s) of the first AI model and distance(s) between the q reference distribution(s) and distribution(s) of the q layer(s) of the second AI model are configured to check whether the first AI model works with the second AI model.

6. The method according to claim 1, further comprising:
receiving second information indicating the q reference distribution(s).

7. An apparatus, comprising:
at least one processor coupled with a memory storing instructions that, when executed by the at least one processor, cause the apparatus to perform operations, wherein the operations comprise:
obtaining distance(s) between q reference distribution(s) and distribution(s) of q layer(s) of a first artificial intelligence (AI) model in an inference cycle, wherein the q reference distribution(s) corresponds to the q layer(s) of the first AI model, and q is a positive integer; and
sending first information according to the distance(s) between the q reference distribution(s) and the distribution(s) of the q layer(s) of the first AI model.

8. The apparatus according to claim 7, wherein the q layer(s) comprises one or more latent layers of the first AI model.

9. The apparatus according to claim 8, wherein the distance(s) between the q reference distribution(s) and the distribution(s) of the q layer(s) of the first AI model is configured to check whether the first AI model works with a second AI model.

10. The apparatus according to claim 9, wherein the q reference distribution(s) is of q layer(s) of the second AI model.

11. The apparatus according to claim 9, wherein the distance(s) between the q reference distribution(s) and the distribution(s) of the q layer(s) of the first AI model and distance(s) between the q reference distribution(s) and distribution(s) of the q layer(s) of the second AI model are configured to check whether the first AI model works with the second AI model.

12. The apparatus according to claim 7, the operations further comprising:
receiving second information indicating the q reference distribution(s).

13. The apparatus according to claim 7, the operations further comprising:
receiving third information indicating q scoring function(s), wherein the q scoring function(s) is configured to measure the distance(s) between the q reference distribution(s) and the distribution(s) of the q layer(s) of the first AI model.

14. An apparatus, comprising:
at least one processor coupled with a memory storing instructions that, when executed by the at least one processor, cause the apparatus to perform operations, wherein the operations comprise:
receiving first information related to distance(s) between q reference distribution(s) and distribution(s) of q layer(s) of a first artificial intelligence (AI) model in an inference cycle, wherein the q reference distribution(s) corresponds to the q layer(s) of the first AI model, and q is a positive integer.

15. The apparatus according to claim 14, the operations further comprising:
receiving second information indicating the q reference distribution(s).

16. The apparatus according to claim 15, wherein the q layer(s) comprises one or more latent layers of the first AI model.

17. The apparatus according to claim 16, wherein the distance(s) between the q reference distribution(s) and the distribution(s) of the q layer(s) of the first AI model is configured to check whether the first AI model works with a second AI model.

18. The apparatus according to claim 17, wherein the q reference distribution(s) is of q layer(s) of the second AI model.

19. The apparatus according to claim 17, wherein the distance(s) between the q reference distribution(s) and the distribution(s) of the q layer(s) of the first AI model and distance(s) between the q reference distribution(s) and distribution(s) of the q layer(s) of the second AI model are configured to check whether the first AI model works with the second AI model.

20. The apparatus according to claim 14, the operations further comprising:
sending third information indicating q scoring function(s), wherein the q scoring function(s) is configured to measure the distance(s) between the q reference distribution(s) and the distribution(s) of the q layer(s) of the first AI model.
